(19) United States
(12) Patent Application Publication
(10) Pub. No.: US 2022/0039368 A1
(43) Pub. Date: Feb. 10, 2022

(54) ROTOR-SUSPENDED BOOM SPRAYER WITH WIDE SPRAY BOOM AND CONTROL METHOD THEREOF

(71) Applicant: South China Agricultural University, Guangzhou (CN)

(72) Inventors: Zhiyan ZHOU, Guangzhou (CN); Zhengtong ZHANG, Guangzhou (CN); Zhaofeng GUAN, Guangzhou (CN); Bingjue LI, Guangzhou (CN); Luohao LIU, Guangzhou (CN); Haitian WU, Guangzhou (CN); Xiwen LUO, Guangzhou (CN); Yuli CHEN, Guangzhou (CN); Lebin LIANG, Guangzhou (CN)

(21) Appl. No.: 17/497,447

(22) Filed: Oct. 8, 2021

Related U.S. Application Data
(63) Continuation of application No. PCT/CN2019/088097, filed on May 23, 2019.

(30) Foreign Application Priority Data
Apr. 8, 2019 (CN) 201910277193.8

(51) Int. Cl. A01M 7/00; B05B 1/20; B05B 15/68

(52) U.S. Cl. CPC A01M 7/0071; B05B 1/20; A01M 7/0089; A01M 7/0042; B05B 15/68

(57) ABSTRACT

A rotor-suspended boom sprayer includes a sprayer body, a pair of polygonal rollers mounted on the sprayer body, and two rotor wide spray booms which are respectively located on either side of the sprayer body when unfolded, the two rotor wide spray booms being unrolled and rolled up by the polygonal roller. Each rotor wide spray boom includes at least one electric motor, at least one propeller correspondingly connected to the electric motor, several sets of rotor spray boom units connected to each other, and several spraying heads provided on the rotor wide spray boom. A self-balancing fixed height system is provided on each rotor wide spray boom to acquire height information and regulate balance and height above the ground of the boom, and the sprayer body is equipped with a main control system connected to the polygonal roller, the electric motor, and the self-balancing fixed height system.

### CROSS REFERENCE TO RELATED APPLICATIONS

The present application is a continuation of International Application No. PCT/CN2019/088097, filed on May 23, 2019, which claims priorities from Chinese Patent Application No. 201910277193.8 filed on Apr. 8, 2019, all of which are hereby incorporated herein by reference.

### TECHNICAL FIELD

The present invention relates to the technical field of sprayers, and in particular to a rotor-suspended boom sprayer with wide spray boom and a control method thereof.

### BACKGROUND

Currently, existing large and medium-sized ground-power crop protection machineries, are primarily in tractor-drawn, suspended or self-propelled forms for load bearing, and mainly perform air-assisted and boom spraying forms for spraying.

An air-assisted sprayer typically uses a tractor or an agricultural vehicle as carrier power, which performs secondary atomization and long-range transport on droplets through a high-speed centrifugal fan air supply system, thereby reaching a long range with higher operating efficiency. However, the air-assisted sprayer is not popularized and used in a large scale in rice production, which is mainly due to limitations of the machinery in practical applications, such as droplets easy to be drifted, poor and imprecise control over spray effects, and susceptibility to road condition limitations, and is difficult to adapt to the needs of rice crop protection.

Large and medium-sized boom spray machines are primarily in tractor-suspended form for load bearing. A spray boom thereof is generally foldable, which can be folded up to facilitate transportation after operation. At present, the maximum working width of an existing machine model may be up to 36 meters, which has high working efficiency and can achieve independent control of a spraying head to enable precise pesticide spraying. A boom sprayer significantly features in overcoming uneven pesticide distribution in a spray gun during pesticide spraying, and greatly reducing spray leakage and repeated pesticide administration. However, when the demanded working width is increased, a larger-sized power machine is required as supporting machinery. Therefore, an overall weight of the spraying machine increases, travelling performance to pass through a farmland is degraded, and easy to sink into the farmland. In addition, in such configuration, energy consumption and loss due to crushed rice seedlings are increased, and working costs are increased. The spray boom is easy to be shaken in spraying operation because of uneven farmland, which leads to more difficulty in controlling balance of the spray boom, two ends of which are liable to touch the ground to damage components, thereby also reducing reliability and convenience of the entire machine. In particular, during a spraying operation on crops (e.g., rice) that require narrow row spacing for agricultural cultivation, a spraying function of the machine model will be largely limited.

In order to adapt to demands of narrow row spacing for paddy crops and travelling in a paddy field, specialized iron wheels suitable for paddy field travelling have been developed, which are added to a common tractor to be retrofitted into a boom sprayer for paddy field with higher working efficiency and even pesticide liquid distribution during spraying, and is suitable for large-area paddy field operations. However, a range of application is limited due to problems of paddy field wheels welded by supporting steel plate of the tractor, such as overweight of the whole machine, large damage to a mud bottom layer, large vibration caused by field operation, large loss due to crushed rows and inconvenience of U-turn in the field.

A manned aircraft has high working efficiency, but causes problems such as a need for a special airport, high maintenance costs, a long time period of a round trip for refilling pesticide liquid, and strict air traffic control. An unmanned helicopter features in no need for special airport and professional pilot, low maintenance costs, and less air traffic control, but also has critical problems that limit the development thereof including low effective load capacity, short working duration, droplets easy to be drifted and resulting in secondary pollution, visual deviation and spray leakage and repeated spraying caused by long-range manual remote control operation, and the like.

### SUMMARY

In view of this, the present invention provides a rotor-suspended boom sprayer with wide spray boom having good safe performance, which is capable of ensuring a horizontal state of the wide spray boom for various attitudes of the machinery and avoiding the spraying head to be in contact with the ground during deflection of the machinery due to long spray boom and wide spray width. Furthermore, the rotor provides a lifting force for the wide spray boom, which eliminates a complicated and bulky truss structure when the spray boom is lengthened, reduces the whole self weight of the machine, increases a passing performance of the ground machine, increases working spray width to reach high effective load capacity of the ground sprayer and higher working efficiency, and can reduce the secondary pollution caused by drifted droplets by a downward wind field.

According to the present invention, the rotor-suspended boom sprayer with wide spray boom includes a sprayer body, a pair of polygonal rollers having polygonal cross sections, which is mounted on the sprayer body, and rotor wide spray booms mounted on the pair of polygonal rollers and respectively located on either side of the sprayer body when the booms are unfolded, Each rotor wide spray boom includes an electric motor, a propeller connected to the electric motor, a plurality of rotor spray boom units connected to each other, and several spraying heads provided on the rotor wide spray boom. The propeller is used for providing a lifting force for the rotor wide spray boom. The polygonal roller is used for unrolling and rolling up the rotor wide spray boom. A self-balancing fixed height system is provided on the rotor wide spray boom to acquire height information and regulate balance and height above the ground of the boom. The sprayer body is equipped with a main control system connected to the polygonal roller, the electric motor, and the self-balancing fixed height system.

The sprayer body may be a tractor or an agricultural vehicle, which can travel in the field. The main control system controls the polygonal rollers to unroll and roll up the rotor wide spray boom before and after operation of the rotor wide spray boom. A motor and a corresponding propeller may be provided on each set of rotor spray boom unit. An electric motor and a corresponding propeller may, of course, be provided every few rotor spray boom units. Each set of rotor spray boom unit is preferably provided with an electric motor and a corresponding propeller.

In the present invention, the height information acquired front the self-balancing fixed height system is transmitted to the main control system that controls a rotational speed of the electric motor after processing the height information to adjust the lifting force provided by the propeller for the rotor wide spray boom in real time, so that the sprayer can ensure a horizontal state of the rotor wide spray boom for various attitudes of the sprayer body, thereby avoiding the spraying head to be in contact with the ground during deflection of the sprayer body due to long spray boom and wide spray width. Furthermore, the propeller provides a lifting force for the rotor wide spray boom, which eliminates a complicated and bulky truss structure when the spray boom is lengthened, reduces the whole self weight of the machine, increases a passing performance of the ground machine, increases working spray width to reach high effective load capacity of the ground sprayer and higher working efficiency, and can reduce the secondary pollution caused by drifted droplets by the downward wind field.

In one of the embodiments, the sprayer body is equipped with a power source and a pesticide liquid supply system that are connected to the main control system. The power source is used to provide electrical energy for the sprayer. The pesticide liquid supply system includes a pesticide liquid tank, a water pump, and a pesticide liquid tube. The water pump is mounted on the pesticide liquid tank and is connected to the main control system, the pesticide liquid tube is distributed and mounted on a rotor wide spray boom and is in communication with the spraying head, and the water pump is used to pump the pesticide liquid within the pesticide liquid tank into the spraying head. The sprayer regulates the operation in real time through the main control system to achieve precise pesticide administration.

In one of the embodiments, the sprayer body is provided with a roller base on which a roller frame is provided, a polygonal roller is mounted on the roller frame; centers of the roller base and the roller frame are connected by a bearing, and the roller base and the roller frame are connected by springs at four corners. The arrangement of bearing and springs have certain shock absorption and buffer effects while the rotor wide spray booms on both sides are adjusted to the horizontal state in real time by controlling the rotational speed of the propeller.

In one of the embodiments, the roller base is connected to the sprayer body by a central shaft, a pulley and a sliding rail, and the pulley is movable along the sliding rail. The pulley is provided on the roller base, and the sliding rail is provided on the sprayer body. Preferably, the pulley is provided at a bottom end of the roller base, and the sliding rail is provided on the sprayer body, so that the arrangement facilitates relative rotation of the roller base and the sprayer body. The polygonal rollers function as a bridge connecting the sprayer body and the rotor wide spray boom, and are lengthwise placed in a left-right direction on the roller frame. In a non-operating state, rotating the entire roller base by 90° relative to the sprayer body can save space and facilitate transportation; of course. The polygonal rollers can also be transversely mounted on the roller frame, i.e., disposed on the roller frame back and forth, which saves space and facilitates transportation without rotating the roller base to switch operating and non-operating states.

In one of the embodiments, adjacent rotor spray boom units are connected by a limit folding fastener. The limit folding fastener includes a male connector, a female connector, and a stop plate. The male connector and the female connector are in rotary connection. The stop plate is used to limit a relative rotational angle of the male connector and female connector. The stop plate can be provided on either the male connector or the female connector, the male connector of the limit folding fastener is connected to one rotor spray boom unit, a corresponding female connector is connected to the other rotor spray boom unit, and the limit folding fastener facilitates interconnection among the rotor spray boom units. The stop plate can stop the male and female connectors to continue relative rotation when the male and female connectors are rotated up to a level state at most.

In one of the embodiments, the rotor wide spray boom is wound on a polygonal roller when rolled up. The number of sides of the polygonal roller is N (N≥3), and N sets of rotor spray boom units of the rotor wide spray boom is taken as a group and wrap around a polygonal roller. When the number of wound turns is denoted as m, the number of the rotor spray boom units is m×N sets. A kN-th (k is a natural number, 1≤k≤m) set of rotor spray boom unit has a folded polygonal-line structure. Other sets of rotor spray boom units have a linear structure, which is convenient for rolling up a next circle of rotor spray boom units.

In one of the embodiments, the self-balancing fixed height system includes a laser guided fixed height system, which includes a holder sliding rail mounted on the roller base and a laser emitter holder mounted on the holder sliding rail. The laser emitter holder is equipped with a laser emitter, and a terminal-end rotor spray boom unit of the rotor wide spray boom is provided with a laser signal reception system for receiving signals from the laser emitter. The laser emitter holder is used to adjust the laser emitter to be in a horizontal state. The laser emitter holder is slidable along the holder sliding rail, and can be manually slid or automatically slid by setting a driving device. When a pair of polygonal rollers are transversely mounted on the roller frame, the rotor wide spray booms may abut against the laser emitter after the polygonal rollers roll up the rotor wide spray booms, which can be avoided by sliding the laser emitter holder along the holder sliding rail to a middle position before rolling up the rotor wide spray booms. A laser beam emitted by the laser emitter is projected onto the laser signal reception system fixed to the terminal-end rotor spray boom unit of the rotor wide spray boom.

In one of the embodiments, the laser signal reception system includes a laser signal reception device and a camera. The camera identifies and transmits an image of the laser signal reception device to the main control system. The main control system identifies light spot position coordinates by image recognition and processing, and controls the lifting force of the propeller on the rotor wide spray boom according to the light spot position coordinates to ensure that the rotor wide spray booms on both sides are located on the same horizontal plane.

In one of the embodiments, the self-balancing fixed height system includes a radar copying fixed height system, which includes a fixed height radar mounted on a terminal-end rotor spray boom unit of the rotor wide spray boom and used for detecting a distance between the terminal-end rotor spray boom unit and a crop canopy in real time and transmitting the distance to the main control system. The main control system controls the lifting force of the propeller on the rotor wide spray boom according to the distance between the terminal-end rotor spray boom unit and the crop canopy to ensure that the rotor wide spray booms on both sides are located on a horizontal plane or can be used for timely terrain following operation.

The laser guided fixed height system and the radar copying fixed height system can be replaced for use in different situations. Preferably, the laser guided fixed height system is used when the polygonal rollers unroll and roll up the rotor wide spray booms before and after operation, and the radar copying fixed height system is used during operation.

The present invention further provides a control method of the rotor-suspended boom sprayer with wide spray boom mentioned above, including the following steps using the above sprayer.

S1, the main control system first starting the self-balancing fixed height system, followed by starting the electric motor that controls rotation of a propeller at an outermost end, in which a direction of the propeller from far to near the polygonal roller when the rotor wide spray booms are in an unfolded state is denoted as a direction from outside to inside;

S2, the self-balancing fixed height system starting operation, transmitting the height information acquired by the self-balancing fixed height system to the main control system, the main control system controlling the rotational speed of the electric motor after processing the height information to adjust the lifting force provided by the propeller for the rotor wide spray booms in real time, and allowing the rotor wide spray booms on both sides of the polygonal rollers to maintain a horizontal state;

in which the self-balancing fixed height system includes the laser guided fixed height system or the radar copying fixed height system, both of which can be replaced for use in different situations, the laser guided fixed height system is used when the polygonal rollers unroll and roll up the rotor wide spray booms before and after operation, and the radar copying fixed height system is used during operation;

when the laser guided fixed height system is used, the laser emitter holder slides along the holder sliding rail to adjust a position of the laser emitter such that the laser emitter is in a horizontal state. The laser emitter emits a horizontal laser beam to be projected onto the laser signal reception device. The main control system obtains a light spot coordinate position by performing light spot identification on an image transmitted by the camera, and adjusts the lifting force of the propeller on the rotor spray boom unit in real time according to the light spot coordinate position such that the rotor wide spray booms on both sides are parallel to the laser beam;

when a radar copying fixed height system is used, the fixed height radar mounted on the terminal-end rotor spray boom unit of the rotor wide spray boom detects the distance between the terminal-end rotor spray boom unit and the crop canopy in real time and transmits the distance to the main control system; the main control system controls the lifting force of the propeller on the rotor wide spray boom according to the distance between the terminal-end rotor spray boom unit and the crop canopy to ensure that the rotor wide spray booms on both sides are located on the horizontal plane or can be used for timely terrain following operation;

S3, when the terminal-end rotor spray boom unit is in the horizontal state, the main control system controlling rotation of the polygonal rollers and sequentially unfolding the rotor spray boom units, propellers correspondingly and sequentially being started from outside to inside, the self-balancing fixed height system obtaining the height information in real time and transmitting the height information to the main control system, the main control system controlling the rotational speed of the electric motor after processing the height information to adjust the lifting force provided by the propeller for the rotor wide spray booms in real time and adjust attitudes of the rotor wide spray booms on both sides until the rotor spray boom units on both sides that meet a spray width requirement are completely unfolded, and corresponding propellers being all started to run. Attitude adjustment of the rotor wide spray booms on both sides specifically including: the main control system acquiring the light spot coordinate position of the laser beam by the laser guided fixed height system, adjusting the lifting force of the propeller on the rotor spray boom unit in real time according to the light spot coordinate position, and adjusting the attitudes of the rotor wide spray booms on both sides such that the rotor wide spray booms on both sides are parallel to the laser beam;

S4, the sprayer body beginning travelling in the field for precise pesticide administration;

S5, during operation, the self-balancing fixed height system on the sprayer body acquiring the height information in real time, the main control system adjusting the rotational speed of the electric motor in real time after processing the height information to adjust the lifting force provided by the corresponding propeller for the rotor wide spray boom in real time, the lifting force being a balance acting force for the rotor wide spray boom to maintain a horizontal state during deflection of the sprayer body. Adjustment of the rotor wide spray boom specifically including, the radar copying fixed height system detecting the distance between the terminal-end rotor spray boom unit and the crop canopy in real time and transmitting the distance to the main control system, the main control system controlling the lifting force of the propeller on the rotor wide spray boom according to the distance between the terminal-end rotor spray boom unit and the crop canopy to ensure that the rotor wide spray booms on both sides are located on the horizontal plane or can be used for timely terrain following operation; and

S6, after operation is completed, the main control system controlling the polygonal rollers to rotate to roll up the rotor spray boom units, stopping the propellers sequentially from inside to outside as the rotor spray boom units are rolled up, and eventually completing the rolling up to end the operation.

The present invention can obtain some beneficial effects.

1. The height information acquired by the self-balancing fixed height system is transmitted to the main control system, which controls the rotational speed of the electric motor after processing the height information to adjust the lifting force provided by the propeller for the rotor wide spray boom in real time, so that the sprayer can ensure a horizontal state of the rotor wide spray boom for various attitudes of the sprayer body, thereby avoiding the spraying head to be in contact with the ground during deflection of the sprayer body due to long spray boom and wide spray width. Furthermore, the propeller provides a lifting force for the rotor wide spray boom, which eliminates a complicated and bulky truss structure when the spray boom is lengthened, reduces the whole self weight of the machine, increases a passing performance of the ground machine, increases working spray width to reach high effective load capacity of the ground sprayer and higher working efficiency, and can reduce the secondary pollution caused by drifted droplets by the downward wind field.

2. with the configuration of the polygonal rollers, the wide spray boom can be foldable, automatic unrolling and rolling up of the wide spray boom can be achieved, thereby further achieving automation and effectively increasing an intelligence level of the sprayer.

3. In order to better to wind a plurality of rigid rotor wide spray booms on the polygonal rollers, the present invention is configured that, when the number of sides of the polygonal roller is N and the number of wound turns is in, a kN-th (k is a natural number, 1≤k≤m) set of rotor spray boom unit has a folded polygonal-line structure so as to be convenient for effectively rolling up the rotor spray boom units.

4. The present invention combines laser with a vision tracking algorithm, enables real-time height fixing of the spray boom under laser guidance, and effectively enhances operation stability of the rotor suspended wide spray boom.

### BRIEF DESCRIPTION OF TILE DRAWINGS

FIG. 1 is a schematic structural view of a rotor-suspended boom sprayer with wide spray boom according to an embodiment of the present invention.

FIG. 2 is a schematic view of rolling up when polygonal rollers are lengthwise placed according to the embodiment of the present invention.

FIG. 3 is a schematic view of installing the polygonal rollers in a lengthwise direction according to the embodiment of the present invention.

FIG. 4 is a schematic view of reset rotation of the polygonal rollers according to the embodiment of the present invention.

FIG. 5 is a detailed schematic view of a linear rotor spray boom unit according to the embodiment of the present invention.

FIG. 6 is a schematic view for installing a kN-th set of polygonal-line rotor spray boom units according to the embodiment of the present invention.

FIG. 7 is a detailed schematic view of the kN-th set of the polygonal-line rotor spray boom units according to the embodiment of the present invention.

FIG. 8 is a schematic structural view of a limit folding fastener according to the embodiment of the present invention.

FIG. 9 is a detailed schematic view of a laser guided fixed height system according to the embodiment of the present invention.

FIG. 10 is a detailed schematic view of a terminal-end radar copying fixed height system of the linear rotor spray boom unit according to the embodiment of the present invention.

FIG. 11 is a schematic view of a pesticide liquid supply system according to the embodiment of the present invention.

FIG. 12 is a schematic view for installing polygonal rollers in a transverse direction according to another embodiment of the present invention.

FIG. 13 is a schematic view of rolling up rotor wide spray booms according to the embodiment of the present invention.

FIG. 14 is a schematic diagram of operation control in the rotor-suspended boom sprayer with wide spray boom according to one embodiment of the present invention.

### DETAILED DESCRIPTION

To provide a clearer understanding of the objects, technical solutions and advantages of the present invention, the present invention will be further described in detail with reference to the accompanying drawings and embodiments. It should be understood that the embodiments described herein are for illustration of the present invention only and are not intended to limit the scope of the present invention.

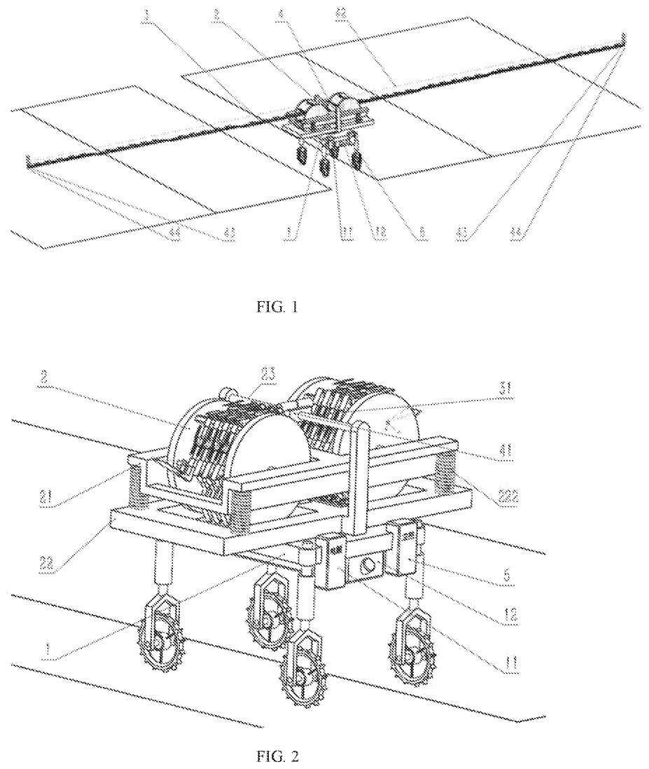

As shown in FIGS. 1 and 2, a rotor-suspended boom sprayer with wide spray boom according to an embodiment includes a sprayer body 1, a pair of polygonal rollers 2 having polygonal cross sections and mourned on the sprayer body 1, and rotor wide spray booms 3 mounted on the polygonal rollers 2 and respectively located on either side of the sprayer body 1 when unfolded. Each rotor wide spray boom 3 includes an electric motor 32, a propeller 33 connected to the electric motor 32, a plurality of rotor spray boom units 31 connected to each other, and several spraying heads 34 provided on the rotor wide spray boom 3. The propeller 33 is used for providing a lifting force for the rotor wide spray boom 3. The polygonal roller 2 is used for unrolling and rolling up the rotor wide spray boom 3. On the sprayer body, a laser emitter 411 mounted on a laser emitter holder 41 and a laser signal reception system 43 mounted on a terminal end of the rotor spray boom unit 31 are mutually coordinated to form a self-balancing fixed height system 4 for acquiring height information. The sprayer body 1 is provided with a main control system 5 connected to the polygonal roller 2, the electric motor 32, and the self-balancing fixed height system 4.

The sprayer body 1 may be a tractor or an agricultural vehicle, which can travel in the field. The main control system 5 controls the polygonal rollers 2 to unroll and roll up the rotor wide spray boom 3 before and after operation of the rotor wide spray boom 3. A motor 32 and a corresponding propeller 33 may be provided on each of rotor spray boom units 31. A motor 32 and a corresponding propeller 33 may, of course, be provided every few rotor spray boom units 31. In the present embodiment, each of rotor spray boom units 31 is provided with an electric motor 32 and a corresponding propeller 33.

The height information acquired by the self-balancing fixed height system 4 is transmitted to the main control system 5, which controls a rotational speed of the electric motor 32 after processing the height information to adjust the lifting force provided by the propeller 33 for the rotor wide spray boom 3 in real time, so that the sprayer can ensure a horizontal state of the rotor wide spray boom 3 for various attitudes of the sprayer body, thereby avoiding the spraying heads 34 to be in contact with the ground during deflection of the sprayer body due to long spray boom and wide spray width. Furthermore, the propeller 33 provides a lifting force for the rotor wide spray boom 3, which eliminates a complicated and bulky truss structure when the spray boom is lengthened, efficiently improves traditional mode of operation, increases working spray width to reach high effective load capacity of the ground sprayer and higher working efficiency.

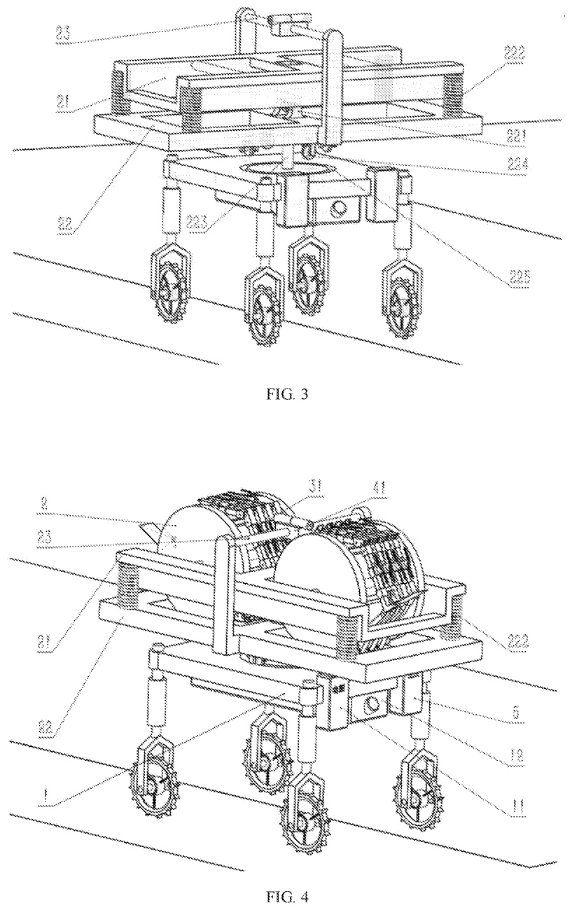

As shown in FIGS. 3 and 4, according to the present embodiment, the sprayer body 1 is provided with a roller base 22 on which a roller frame 21 is provided. The polygonal rollers 2 are mounted on the roller frame 21, and a holder sliding rail 23 is mounted on the roller base 22.

In the present embodiment, centers of the roller base 22 and the roller frame 21 are connected by a bearing 221. The roller base 22 and the roller frame 21 are connected by springs 222 at four corners, which has certain shock absorption and buffer effects while the rotor wide spray booms 3 on both sides are adjusted to the horizontal state in real time.

In the present embodiment, the roller base 22 is connected to the sprayer body 1 by a central shaft 223, a pulley 224 and a sliding rail 225. The pulley 224 is movable along the sliding rail 225. The polygonal rollers 2 are lengthwise placed in a left-right direction on the roller frame 21. In a non-operating state, the entire roller base 22 is rotated by 90° relative to the sprayer body 1, which saves space and facilitates transportation. Rotational connection of the roller base 22 to the sprayer body 1 enables rotation of the pair of polygonal rollers 2 when switching between operating and non-operating states.

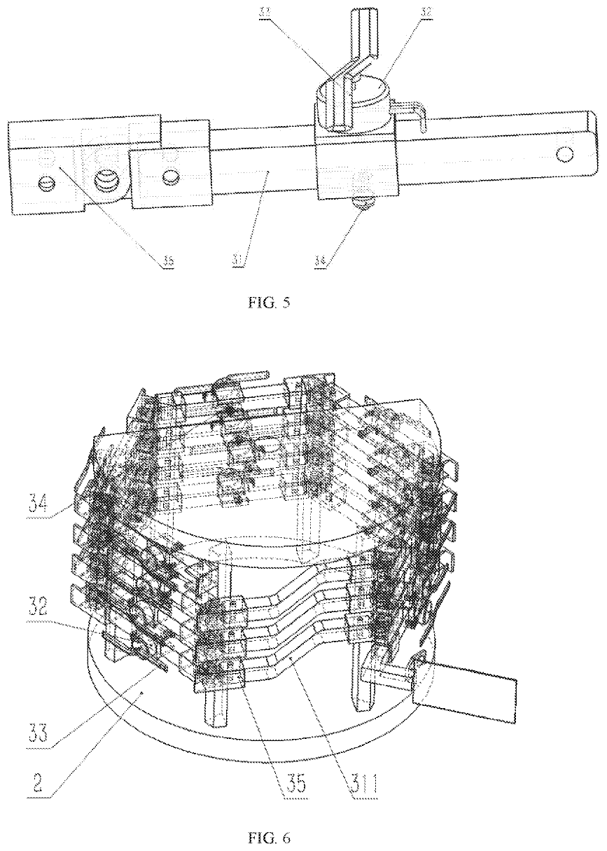

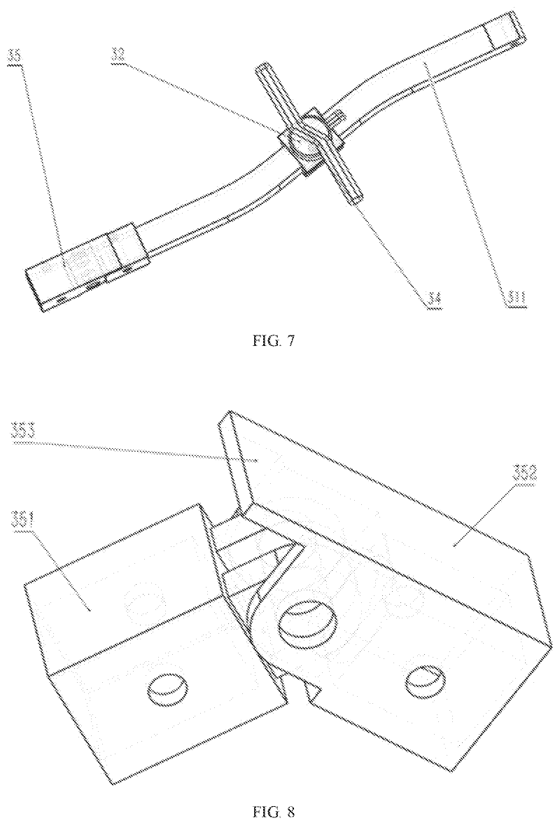

As shown in FIGS. 5 to 8, the rotor wide spray boom 3 is wound on the polygonal roller 2 when rolled up. The number of sides of the polygonal roller 2 is N (N≥3), and N sets of rotor spray boom units 31 of the rotor wide spray boom 3 is taken as a group and wrap around the polygonal roller 2. When the number of wound turns is in, the number of the rotor spray boom units 31 is m×N sets. A kN-th (k is a natural number, 1≤k≤m) set of rotor spray boom unit 311 has a folded polygonal-line structure, while other sets of rotor spray boom units 311 have a linear structure and is convenient for rolling up a next circle of rotor spray boom units 31.

In the present embodiment, adjacent rotor spray boom units 31 are connected by a limit folding fastener 35 including a male connector 351, a female connector 352, and a stop plate 353, in which the male connector 351 and the female connector 352 are in rotary connection, and the stop plate 353 is used to limit a relative rotational angle of the male connector 351 and female connector 352.

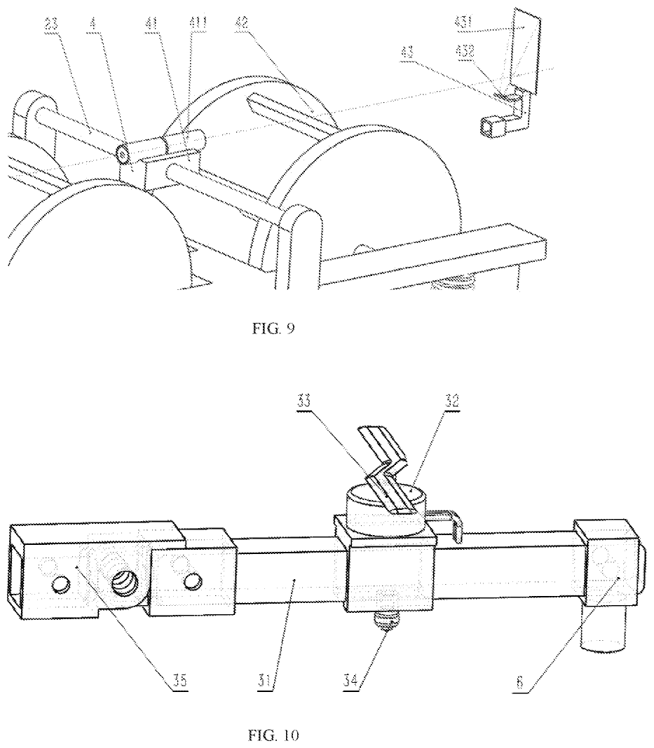

As shown in FIG. 9, according to the present embodiment, the self-balancing fixed height system 4 includes a laser guided fixed height system or a radar copying fixed height system, both of which can be replaced for use in different situations. Preferably, the laser guided fixed height system is used when the polygonal rollers 2 unroll and roll up the rotor wide spray booms 3 before and after operation, and the radar copying fixed height system is used during operation.

The laser guided fixed height system includes a holder sliding rail 23 mounted on the roller base 22 and a laser emitter holder 41 mounted on the holder sliding rail 23. The laser emitter holder 41 is equipped with a laser emitter 411, a laser beam 42 emitted by the laser emitter 411 is projected onto the laser signal reception system 43 fixed to the terminal-end rotor spray boom unit 31 of the rotor wide spray boom 3.

In the present embodiment, the laser signal reception system 43 includes a laser signal reception device 431 and a camera 432. The camera 432 identifies and transmits an image of the laser signal reception device 431 to the main control system 5, the main control system 5 identifies light spot position coordinates by image recognition and processing, and controls the lifting force of the propeller 33 on the rotor wide spray boom 3 according to the light spot position coordinates to ensure that the rotor wide spray booms 3 on both sides are located on the same horizontal plane.

The radar copying fixed height system includes a fixed height radar 44 mounted on the terminal-end rotor spray boom unit 31 of the rotor wide spray boom 3 and used to detect a distance between the terminal-end rotor spray boom unit 31 and a crop canopy in real time and transmits the distance to the main control system 5. The main control system 5 controls the lifting force of the propeller 33 on the rotor wide spray boom 3 according to the distance between the terminal-end rotor spray boom unit 31 and the crop canopy to ensure that the rotor wide spray booms 3 on both sides are located on the horizontal plane or can be used for timely terrain following operation.

As shown in FIG. 11, the sprayer body 1 is equipped with a power source 11 and a pesticide liquid supply system 12 that are connected to the main control system 5. The power source 11 is used to provide electrical energy for the sprayer. The pesticide liquid supply system 12 includes a pesticide liquid tank 121, a water pump 122, and a pesticide liquid tube 123. The water pump 122 is mounted on the pesticide liquid tank 121 and is connected to the main control system 5, the pesticide liquid tube 123 is distributed and mounted on the rotor wide spray boom 3 and is in communication with a spraying head 34. The water pump 122 is used to pump the pesticide liquid within the pesticide liquid tank 121 into the spraying head 34.

As shown in FIG. 14, a control method of the rotor-suspended boom sprayer with wide spray boom is further provided, including the following steps using the above sprayer.

S1, the main control system 5 first starting the self-balancing fixed height system 4, followed by starting the electric motor 32 that controls rotation of a propeller 33 at an outermost end of the rotor spray boom unit 31, in which a direction of the propeller 33 from far to near the polygonal roller 2 when the rotor wide spray booms 3 are in an unfolded state is denoted as a direction from outside to inside;

S2, the self-balancing fixed height system 4 starting operation, transmitting the height information acquired by the self-balancing fixed height system 4 to the main control system 5, the main control system 5 controlling the rotational speed of the electric motor 32 after processing the height information to adjust the lifting force provided by the propeller 33 for the rotor wide spray booms 3 in real time, and allowing the rotor wide spray booms 3 on both sides of the polygonal rollers 2 to maintain a horizontal state;

in which the self-balancing fixed height system 4 includes the laser guided fixed height system or the radar copying fixed height system, both of which can be replaced for use in different situations, the laser guided fixed height system is used when the polygonal rollers 2 unroll and roll up the rotor wide spray booms 3 before and after operation, and the radar copying fixed height system is used during operation;

when the laser guided fixed height system is used, the laser emitter holder 41 slides along the holder sliding rail 23 to adjust a position of the laser emitter 411 such that the laser emitter 411 is in a horizontal state. The laser emitter 411 emits a horizontal laser beam 42 to be projected onto the laser signal reception device 431. The main control system 5 obtains a light spot coordinate position by performing light spot identification on an image transmitted by the camera 432, and adjusts the lifting force of the propeller 33 on the rotor spray boom unit 31 in real time according to the light spot coordinate position such that the rotor wide spray booms 3 on both sides are parallel to the laser beam 42;

when a radar copying fixed height system is used, the fixed height radar 44 mounted on the terminal-end rotor spray boom unit 31 of the rotor wide spray boom 3 detects the distance between the terminal-end rotor spray boom unit 31 and the crop canopy in real time and transmits the distance to the main control system 5. The main control system 5 controls the lifting force of the propeller 33 on the rotor wide spray boom 3 according to the distance between the terminal-end rotor spray boom unit 31 and the crop canopy to ensure that the rotor wide spray booms 3 on both sides are located on the horizontal plane or can be used for timely terrain following operation;

S3, when the terminal-end rotor spray boom unit 31 is in the horizontal state, the main control system 5 controlling rotation of the polygonal rollers 2 and sequentially unfolding the rotor spray boom units 31, the propellers 33 correspondingly and sequentially being started from outside to inside, the self-balancing fixed height system 4 obtaining the height information in real time and transmitting the height information to the main control system 5, the main control system 5 controlling the rotational speed of the electric motor 32 after processing the height information to adjust the lifting force provided by the propeller 33 for the rotor wide spray booms 3 in real time and adjust attitudes of the rotor wide spray booms 3 on both sides until the rotor spray boom units 31 on both sides that meet a spray width requirement are completely unfolded, and corresponding propellers 33 being all started to run. Attitude adjustment of the rotor wide spray booms 3 on both sides specifically including: the main control system 5 acquiring the light spot coordinate position of the laser beam by the laser guided fixed height system, adjusting the lifting force of the propeller 33 on the rotor spray boom unit 31 in real time according to the light spot coordinate position, and adjusting the attitudes of the rotor wide spray booms 3 on both sides such that the rotor wide spray booms 3 on both sides are parallel to the laser beam;

S4, the sprayer body 1 beginning travelling in the field for precise pesticide administration;

S5, during operation, the self-balancing fixed height system 4 on the sprayer body 1 acquiring the height information in real time, the main control system 5 adjusting the rotational speed of the electric motor 32 in real time after processing the height information to adjust the lifting force provided by the corresponding propeller 33 for the rotor wide spray boom 3 in real time, the lifting force being a balance acting force for the rotor wide spray boom 3 to maintain a horizontal state during deflection of the sprayer body. Adjustment of the rotor wide spray boom 3 specifically including: the radar copying fixed height system detecting the distance between the terminal-end rotor spray boom unit 31 and the crop canopy in real time and transmitting the distance to the main control system 5, the main control system 5 controlling the lifting force of the propeller 33 on the rotor wide spray boom 3 according to the distance between the terminal-end rotor spray boom unit 31 and the crop canopy to ensure that the rotor wide spray booms 3 on both sides are located on the horizontal plane or can be used for timely terrain following operation; and

S6, after operation is completed, the main control system 5 controlling the polygonal rollers 2 to rotate to roll up the rotor spray boom units 31, stopping the propellers 33 sequentially from inside to outside as the rotor spray boom units 31 are rolled up, and eventually completing the rolling up to end the operation.

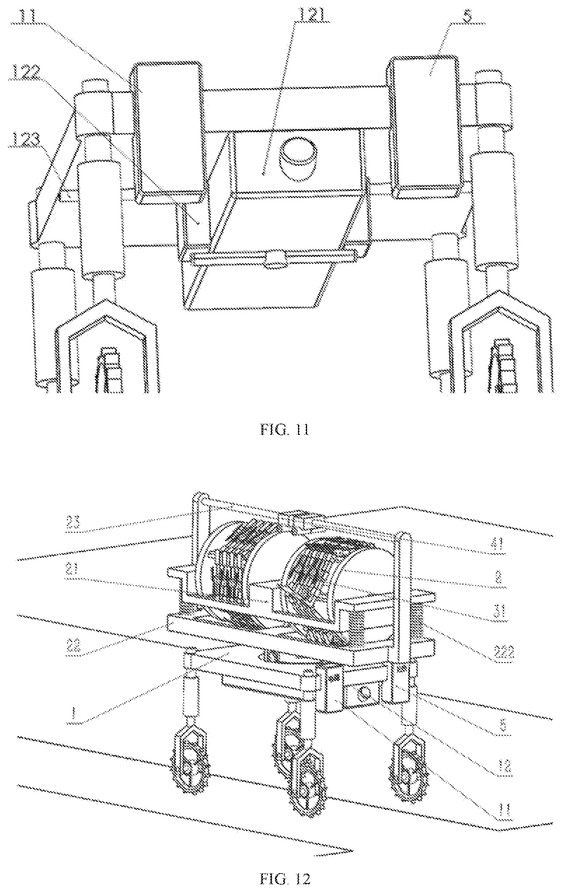

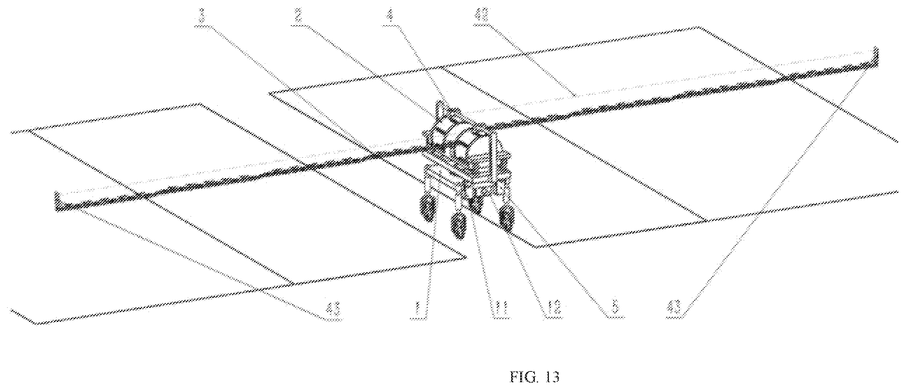

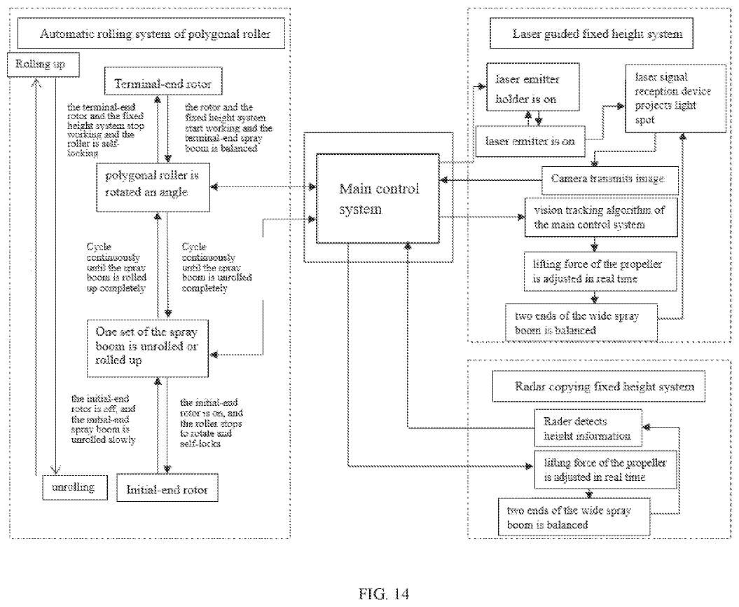

According to another embodiment, a rotor-suspended boom sprayer with wide spray boom includes a structure and a control method substantially the same as in the embodiment mentioned above, which differs in that: a pair of polygonal rollers 2 described in this embodiment are mounted transversely on a roller frame 21, that is, the polygonal rollers 2 are placed on the roller frame 21 back and forth, as shown in FIGS. 12 and 13. Such placement can save space and facilitates transportation without rotating the roller base 22 to switch operating and non-operating states.

The various technical features of the embodiments described above may be combined in any combination, and it is not possible to describe every conceivable combination of all the technical features in the embodiments described above for simplicity of description. However, as long as the combinations of these technical features do not contradict, it should be considered as within the scope described in the specification.

The embodiments described above represent only several embodiments of the present invention, which are specifically described in detail, but it should not be construed as a limitation on the scope of the claims. It should be noted that modifications and improvements can be made by those skilled in the art without departing from the concept of the present invention, and fall within the scope of the present invention. Therefore, the scope of the present invention is defined by the appended claims.

1. A rotor-suspended boom sprayer with wide spray boom, comprising:
a sprayer body;
a pair of polygonal rollers having polygonal cross sections and mounted on the sprayer body; and
two rotor wide spray booms which are mounted on the pair of polygonal rollers and respectively located on either side of the sprayer body when unfolded, the two rotor wide spray booms being unrolled and rolled up by the polygonal roller,
wherein each rotor wide spray boom includes
at least one electric motor;
at least one propeller correspondingly connected to the electric motor, which is configured to provide a lifting force for the rotor wide spray boom;
several sets of rotor spray boom units connected to each other; and
several spraying heads provided on the rotor wide spray boom,
wherein a self-balancing fixed height system is provided on each rotor wide spray boom to acquire height information and regulate balance and height above the ground of the spray boom, and the sprayer body is equipped with a main control system connected to the polygonal roller, the electric motor, and the self-balancing fixed height system.

2. The rotor-suspended boom sprayer with wide spray boom according to claim 1, wherein the sprayer body is equipped with a power source configured to provide electrical energy for the boom sprayer and a pesticide liquid supply system that are connected to the main control system,
wherein the pesticide liquid supply system includes
a pesticide liquid tank;
a water pump which is mounted on the pesticide liquid tank and is connected to the main control system and configured to pump pesticide liquid within the pesticide liquid tank into the spraying heads; and
a pesticide liquid tube, which is distributed and mounted on the rotor wide spray boom and is in communication with a spraying head.

3. The rotor-suspended boom sprayer with wide spray boom according to claim wherein the sprayer body is provided with a roller base on which a roller frame is provided, and the polygonal rollers are mounted on the roller frame, and wherein centers of the roller base and the roller frame are connected by a bearing, and the roller base and the roller frame are connected by springs at four corners of the roller frame.

4. The rotor-suspended boom sprayer with wide spray boom according to claim 3, wherein the roller base is connected to the sprayer body by a central shaft, a pulley and a sliding rail, the pulley is movable along the sliding rail.

5. The rotor-suspended boom sprayer with wide spray boom according to claim 1, wherein adjacent rotor spray boom units are connected by a limit folding fastener, the limit folding fastener includes a male connector, a female connector, and a stop plate used to limit a relative rotational angle of the male connector and female connector, the male connector and the female connector are in rotary connection.

6. The rotor-suspended boom sprayer with wide spray boom according to claim 1, wherein the rotor wide spray boom is wound on the polygonal roller when rolled up, the number of sides of the polygonal roller is N and N≥3, and N sets of rotor spray boom units of the rotor wide spray boom is taken as a group and wrap around the polygonal roller, and
when the number of wound turns is denoted as m, the number of sets of the rotor spray boom units is m×N sets; a kN-th set of a rotor spray boom unit has a folded polygonal-line structure, in which k is a natural number and 1≤k≤m.

7. The rotor-suspended boom sprayer with wide spray boom according to claim 1, wherein the self-balancing fixed height system includes a laser guided fixed height system, which includes a holder sliding rail mounted on a roller base and a laser emitter holder mounted on the holder sliding rail, the laser emitter holder is equipped with a laser emitter, and a terminal-end rotor spray boom unit of the rotor wide spray boom is provided with a laser signal reception system for receiving signals from the laser emitter.

8. The rotor-suspended boom sprayer with wide spray boom according to claim 7, wherein the laser signal reception system includes a laser signal reception device and a camera which is configured to identify and transmit an image of the laser signal reception device to the main control system.

9. The rotor-suspended boom sprayer with wide spray boom claim 1, wherein the self-balancing fixed height system includes a radar copying fixed height system, which includes a fixed height radar mounted on a terminal-end rotor spray boom unit of the rotor wide spray boom and configured to detect a distance between the terminal-end rotor spray boom unit and a crop canopy in real time and transmit the distance to the main control system.

10. A control method of the rotor-suspended boom sprayer with wide spray boom according claim 1, comprising steps of:
S1, the main control system first starting the self-balancing fixed height system, followed by starting the electric motor that controls rotation of the propeller at an outermost end, in which a direction of the propeller from far to near the polygonal roller when the rotor wide spray booms are in an unfolded state are denoted as a direction from outside to inside;
S2, the self-balancing fixed height system starting operation, transmitting the height information acquired by the self-balancing fixed height system to the main control system, the main control system controlling the rotational speed of the electric motor after processing the height information to adjust the lifting force provided by the propeller for the rotor wide spray booms in real time, and allowing the rotor wide spray booms on both sides of the polygonal rollers to maintain a horizontal state;
S3, when the terminal-end rotor spray boom unit is in the horizontal state, the main control system controlling rotation of the polygonal rollers and sequentially unfolding the rotor spray boom units, propellers correspondingly and sequentially being started from outside to inside, the self-balancing fixed height system obtaining the height information in real time and transmitting the height information to the main control system, and the main control system controlling the rotational speed of the electric motor after processing the height information to adjust the lifting force provided by the propeller for the rotor wide spray booms in real time and adjust attitudes of the rotor wide spray booms on both sides until the rotor spray boom units on both sides that meet a spray width requirement are completely unfolded, and corresponding propellers being all started to run;
S4, the sprayer body beginning travelling in the field for precise pesticide administration;
S5, during operation, the self-balancing fixed height system on the sprayer body acquiring the height information in real time, the main control system adjusting the rotational speed of the electric motor in real time after processing the height information to adjust the lifting force provided by the corresponding propeller for the rotor wide spray boom in real time, the lifting force being a balance acting force for the rotor wide spray boom to maintain a horizontal state during deflection of the sprayer body; and
S6, after operation is completed, the main control system controlling the polygonal rollers to rotate to roll up the rotor spray boom units, stopping the propellers sequentially from inside to outside as the rotor spray boom units are rolled up, and eventually completing the rolling up to end the operation.
